(19) United States
(12) Patent Application Publication
(10) Pub. No.: US 2021/0309170 A1
(43) Pub. Date: Oct. 7, 2021

(54) GROMMET

(71) Applicant: Illinois Tool Works Inc., Glenview, IL (US)

(72) Inventor: Scott M. Liebelt, Eau Claire, WI (US)

(21) Appl. No.: 17/032,948

(22) Filed: Sep. 25, 2020

Related U.S. Application Data
(60) Provisional application No. 63/005,639, filed on Apr. 6, 2020.

(51) Int. Cl. B60R 16/02; F16B 5/00

(52) U.S. Cl. CPC B60R 16/0222; F16B 5/00

(57) ABSTRACT

A grommet has a body that includes a longitudinal axis and has a passageway therein. The grommet further includes a collar and a box prong. The collar extends from the body and away from the longitudinal axis. The box prong extends circumferentially around the body. A plurality of longitudinal openings extend through the body and the box prong at diametrically opposed sides. The grommet is configured to attach within a slot of a component in any orientation.

### CROSS REFERENCE TO RELATED APPLICATIONS

Not applicable

### BACKGROUND OF THE INVENTION

### 1. Field of the Invention

The present invention relates generally to fasteners and, more particularly, to a grommet that assists in securing one or more components together, such as panels within or around a vehicle that are secured together during the manufacturing process of the vehicle.

### 2. Description of the Background of the Invention

Fasteners may be used to secure components together. Grommets are a type of fastener that typically comprise a ring or edge strip. Grommets are generally flared or collared on each side to keep them in place, and are often made of metal, plastic, or rubber. In some instances, grommets may be used to prevent tearing or abrasion of pierced materials, to cover sharp edges of piercings, to protect the insulation of wires, cables, or lines being routed therethrough, or for securing components together.

In the automotive context, grommet fasteners may be used to securely connect a first panel to a second panel. Many known grommets are configured to be used in a round hole. As such, many known grommets are unable to be used in a slot. Further, many prior art grommets require proper orientation prior to attaching the grommet to the slot of the first panel and/or the second panel. Furthermore, many prior art grommets require a high installation force.

A need therefore exists for a grommet that can be used in a slot without the need to properly orientate the grommet during installation. Further, a need exists for a grommet with a low installation force.

### SUMMARY OF THE INVENTION

In one aspect, a grommet comprises a body that is defined by a longitudinal axis and has a passageway therein. The grommet further comprises a collar and a box prong. The collar extends from the body and away from the longitudinal axis. The box prong extends circumferentially around the body. A plurality of longitudinal openings extend through the body and the box prong at diametrically opposed sides. The grommet is configured to attach within a slot of a component in any orientation.

### BRIEF DESCRIPTION OF THE DRAWINGS

The invention will be better understood and features, aspects, and advantages other than those set forth above will become apparent when consideration is given to the following detailed description thereof. Such detailed description makes reference to the following drawings.

FIG. 1 is a top perspective view of a grommet, according to an embodiment of the present disclosure;

FIG. 2 is a bottom perspective view of the grommet of FIG. 1;

FIG. 3 is a side elevational view of the grommet of FIG. 1;

FIG. 4 is a front elevational view of the grommet of FIG. 1;

FIG. 5 is a top plan view of the grommet of FIG. 1;

FIG. 6 is a bottom plan view of the grommet of FIG. 1;

FIG. 7 is a cross-sectional view taken through line 7-7 of FIG. 3;

FIG. 8 is a side elevational view of a pin in accordance with the present disclosure;

FIG. 9 is a perspective view of the grommet of FIG. 1 aligned with a component;

FIG. 10 a perspective view of the grommet of FIG. 1 aligned with the component of FIG. 9 and the pin of FIG. 8;

FIG. 11 is front elevational view of the grommet of FIG. 1 attached to the component of FIG. 9 and the pin of FIG. 8;

FIG. 12 is a side elevational view of the grommet of FIG. 1 attached to the component of FIG. 9 and the pin FIG. 8; and

FIG. 13 is a cross-sectional view taken through line 13-13 of FIG. 12.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE DRAWINGS

Embodiments of the present disclosure provide for a grommet. Specifically, a grommet with a plurality of longitudinal openings that extend through a box prong. The features described herein allow for the grommet to be inserted quickly into a slot, without the need to be properly orientated within the slot. Therefore, the present disclosure provides for a grommet that greatly reduces the time and complexity of installing it.

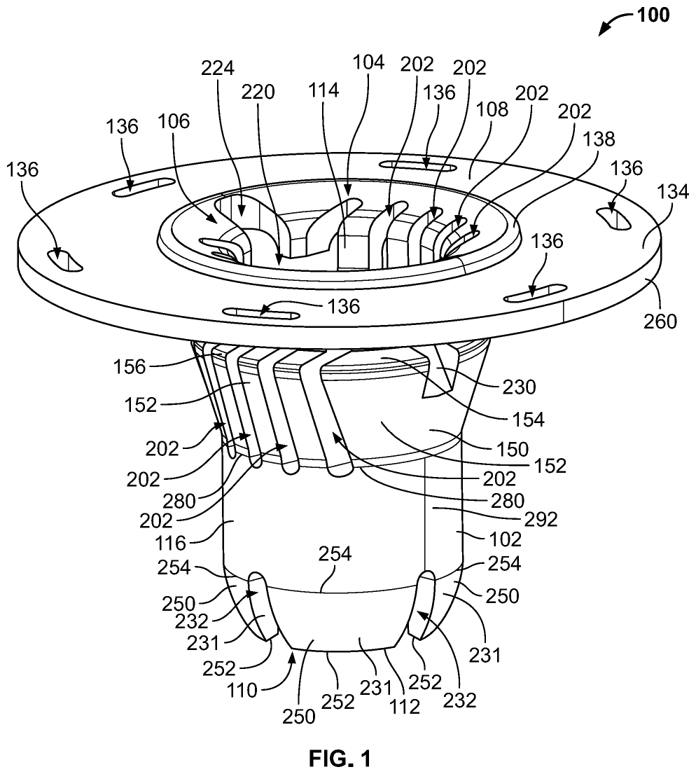

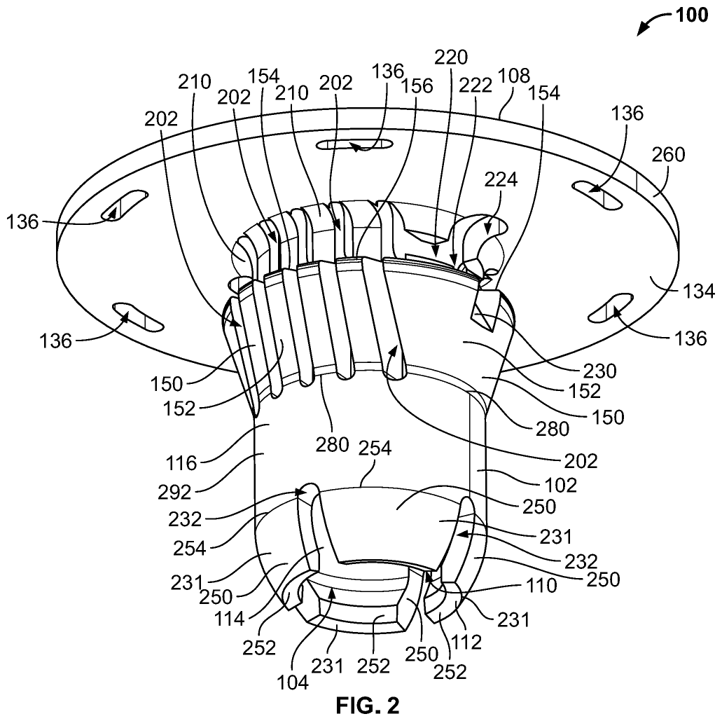

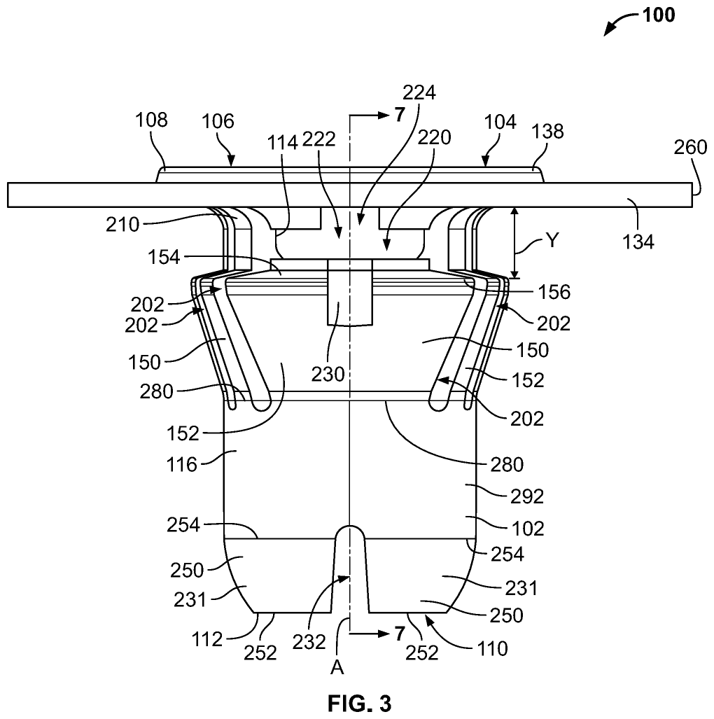

FIGS. 1-7 illustrate a fastener or grommet 100 in accordance with the present disclosure. Referring to FIGS. 1 and 2, a top and a bottom perspective view of the grommet 100 are shown, respectively. As illustrated in FIG. 1, the grommet 100 comprises a round shape when viewed from the top and bottom, and the grommet 100 includes a body 102 that is generally cylindrical. The grommet 100 may be integrally molded and formed as a single piece of material, such as injection-molded plastic. Further, the grommet 100 includes a passageway 104 defined by a first or upper opening 106 at a first or upper end 108 and a second or lower opening 110 at a second or bottom end 112. The passageway 104 is partially defined by an inner surface 114 of a wall 116 that is generally cylindrical or may be slightly tapered. The wall 116 extends between the upper opening 106 and the lower opening 110, with several interrupted portions, as outlined in greater detail below. Referring to FIG. 3, the upper opening 106 has a diameter that is larger than a diameter of the lower opening 110. Further, a longitudinal axis A extends through a center of the passageway 104.

Referring to FIG. 1, a collar 134 is disposed peripherally about the upper end 108 of the body 102, and extends radially outward therefrom. A plurality of elongate apertures 136 are provided within the collar 134, which may provide for attachment of the grommet 100 to an object, such as a steel panel (not shown). The plurality of elongate apertures 136 may be provided in a number of different configurations, and any number of elongate apertures 136 may be included. Alternatively, the grommet 100 may not include the apertures 136 along the collar 134. A flange 138 extends outwardly from an intersection of the collar 134 and the body 102, in a direction that is substantially parallel with respect to the longitudinal axis A (see FIG. 3).

Referring still to FIGS. 1 and 2, a box prong 150 extends outward from the body 102. The box prong 150 extends circumferentially around the body 102 and comprises a generally frusto-conical shape. In particular, the diameter of the box prong 150 increases as it extends upwardly toward the collar 134. As illustrated in FIGS. 1 and 2, the box prong 150 comprises an angled wall 152 that extends from the wall 116 of the body 102. The angled wall 152 extends radially outward from the body 102 and longitudinally toward the collar 134. In alternative embodiments, the box prong 150 may only extend partially around the body 102 of the grommet 100.

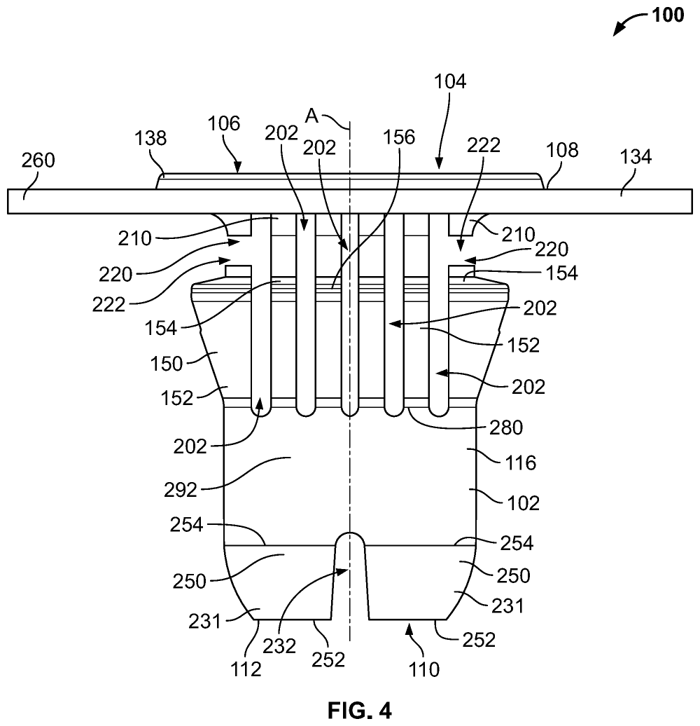

Referring to FIGS. 3 and 4, a side view and a front elevational view of the grommet 100 are shown. As illustrated in FIGS. 3 and 4, the box prong 150 comprises a top wall 154 that extends radially outward from the wall 116 of the body 102. In the present embodiment, the top wall 154 comprises a slight angle with respect to the collar 134. However, in alternative embodiments, the top wall 154 may be substantially flat or parallel with the collar 134. Additionally, the top wall 154 of the box prong 150 extends from the wall 116 of the body 102 and connects with the angled wall 152 of the box prong 150. In preferred embodiments, the box prong 150 comprises a rounded corner 156 where the top wall 154 and the angled wall 152 meet. As noted herein, the top wall 154 of the box prong 150 is located at a distance Y away from the collar 134 (see FIG. 3).

Referring to FIGS. 1-4, a plurality of longitudinal openings 202 extend through the body 102 of the grommet 100 at diametrically opposed front and rear sides. In particular, the plurality of longitudinal openings 202 extend through the wall 116 of the body 102 and the box prong 150 of the grommet 100. In some embodiments, the longitudinal openings 202 may extend through a portion of the collar 134. As illustrated in FIG. 4, the longitudinal openings 202 are aligned with each other on opposite sides of the body 102 of the grommet 100. In other embodiments, the longitudinal openings 202 may not align with each other on opposite sides of the body 102 of the grommet 100. As noted herein, the grommet 100 comprises five longitudinal openings 202 that extend on each side of the body 102. However, in alternative embodiments, the grommet 100 may include more or fewer longitudinal openings 202 than shown. Further, in other embodiments, the plurality of longitudinal openings 202 may extend on different sides of the body 102 of the grommet 100.

Referring to FIG. 2, the body 102 of the grommet 100 is shown more clearly, and a fillet 210 that forms a connection between the collar 134 and the body 102 is illustrated. The fillet 210 extends radially about the longitudinal axis A (see FIG. 3), and is interrupted at various points by the longitudinal openings 202 in the body 102 of the grommet 100. Further, the fillet 210 is interrupted at diametrically opposed sides by windows 220 that define openings within the body 102 of the grommet 100. While the present embodiment includes two of the windows 220, the same reference numbers apply to like elements of each of the windows 220 as described hereinafter below. As such, only a single window 220 is described and referred to herein, however, the windows 220 are identical, and the description of one relates to the description of the other.

Still referring to FIG. 2, the window 220 extends from the collar 134 toward the bottom end 112 of the body 102. As illustrated in FIG. 3, the window 220 comprises a central segment 222 and a top portion 224 that extends above the central segment 222. In this embodiment, a portion of the wall 116 extends toward the central segment 222. As noted herein, the windows 220 allow the grommet 100 to have a lower installation force. In alternative embodiments, the grommet 100 may not comprise the window 220 on each side of the grommet 100. In such an embodiment, the wall 116 of the body 102 may extend all the way up to the fillet 210 (see FIG. 3). Referring specifically to FIG. 3, a cutout 230 extends into the box prong 150 on diametrically opposed sides of the box prong 150. In some embodiments, the box prong 150 may not include the cutout 230.

Referring still to FIG. 2, a plurality of legs 231 extend from the body 102 adjacent the lower opening 110. The legs 231 are separated by a plurality of longitudinal slits 232, which generally define the legs 231. In preferred embodiments, the grommet 100 may include four of the legs 231 that extend from the body 102. Alternatively, the grommet 100 may include more or fewer legs 231 than shown. Each of the legs 231 may include an extension beam 250 and an inwardly-canted tip 252 extending from the extension beam 250. In operation, the securing legs 231 are configured to outwardly pivot about flexure joints 254 that connect the legs 231 with the body 102 as a tool or other object is moved into the central passageway 104. In some embodiments, the securing legs 231 are capable of pivoting outwardly at the flexure joints 254 to expand in order to secure the grommet 100 into an opening of a component, such as a panel.

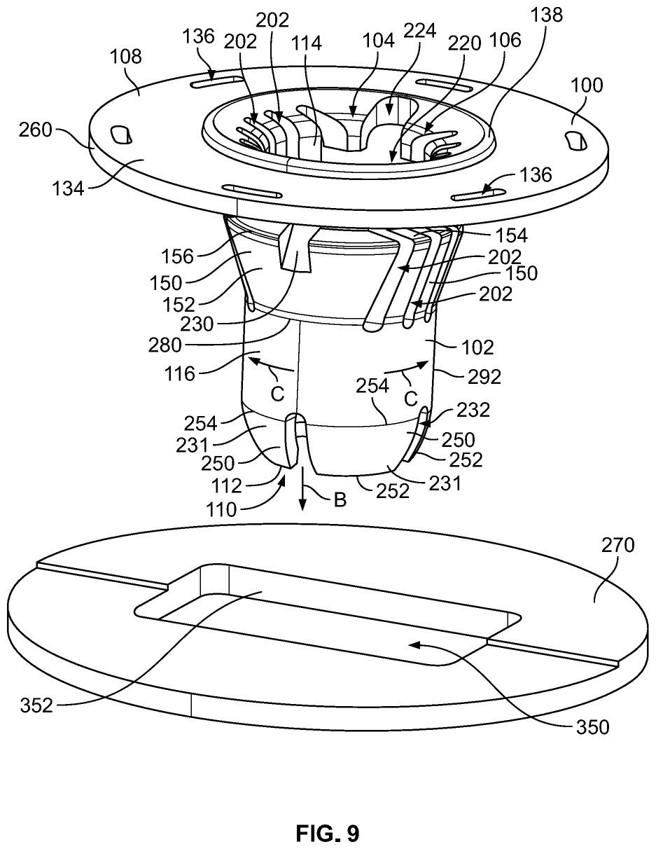

Referring to FIGS. 3 and 4, the collar 134 is shown in elevation, the collar 134 being generally cylindrical in nature and having a peripheral side 260 that extends in a direction parallel with respect to the longitudinal axis A. As described in greater detail hereinafter below, the box prong 150 is flexible and is formed to retract into the passageway 104 of the grommet 100 when drawn therein through a component 270 (see FIG. 9). An intersection or joint 280 between the box prong 150 and the body 102 is generally flexible, and allows the box prong 150 to retract inward, once a force is applied.

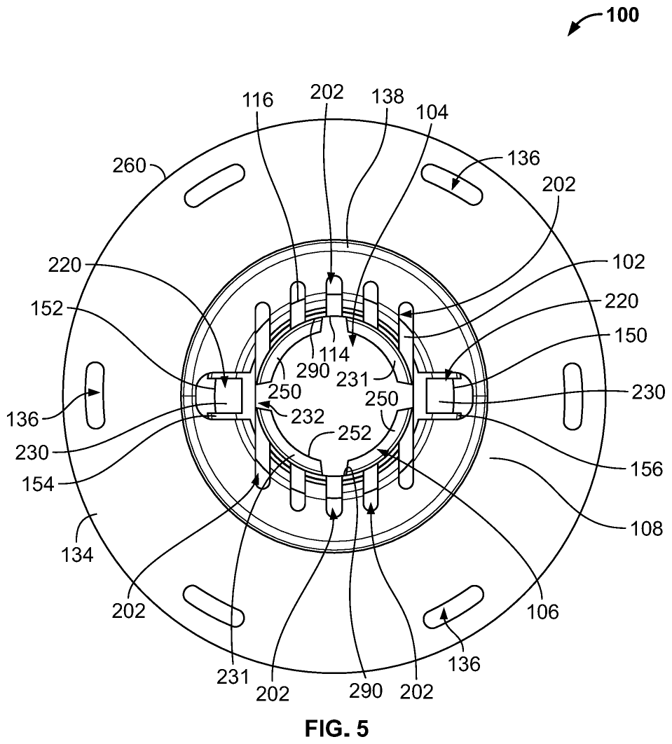

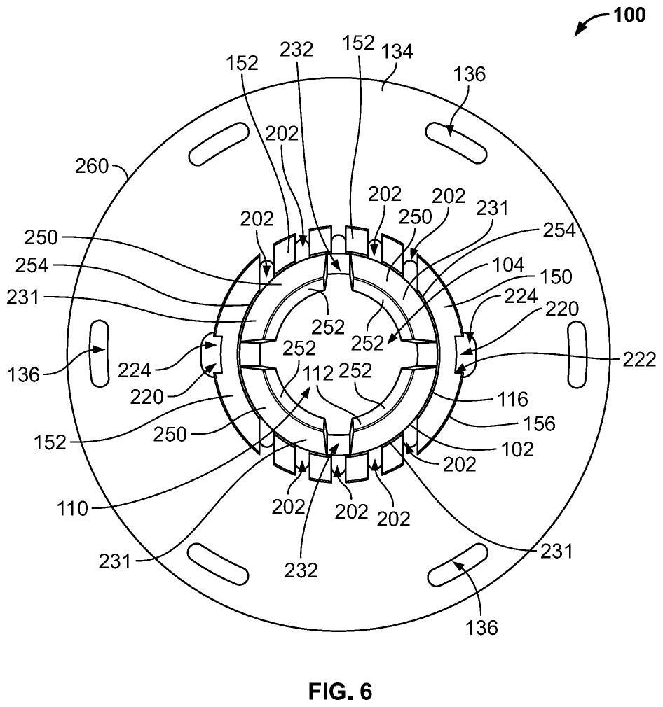

Referring to FIGS. 5 and 6, a top and a bottom plan view of the grommet 100 are shown. Referring specifically to FIG. 5, the plurality of longitudinal openings 202 also extend through the upper end 108 of the grommet 100. As illustrated in FIG. 6, the angled wall 152 of the box prong 150 can be clearly seen extending from the body 102 of the grommet 100.

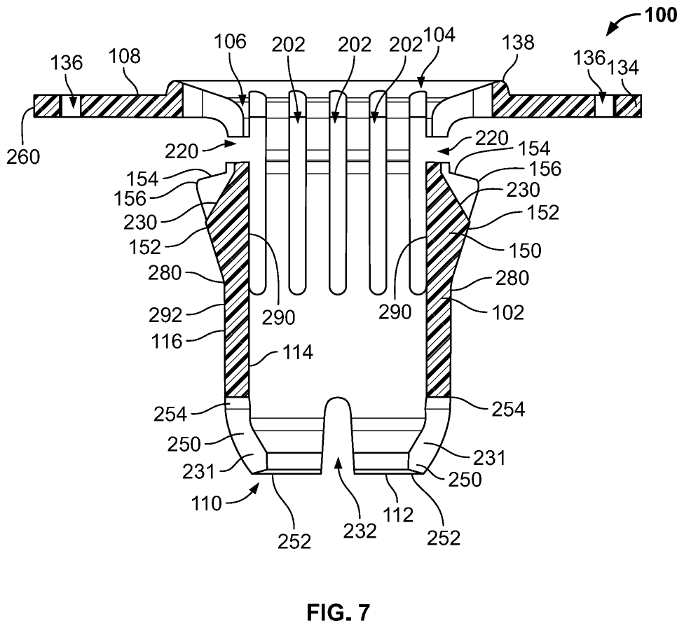

Referring to FIG. 7, a cross-sectional view of the grommet 100 is shown. Specifically, the box prong 150 is shown extending outward from the joints 280, away from the longitudinal axis A (see FIG. 3). The grommet 100 of FIG. 7 is shown in a non-retracted, first state. The box prong 150 includes an inner surface 290 that is generally flush with the inner surface 114 of the wall 116 in the first state. The angled wall 152 of the box prong 150 is offset with respect to an outer surface 292 of the body 102 in the first state, and is generally flush and coincident with the outer surface 292 of the body 102 in a second, or retracted state. In alternative embodiments, the grommet 100 may include arms instead of or with the box prong 150 similar to the type disclosed in U.S. patent application Ser. No. 16/722,730 and United States Patent Publication No. 2020/0141440, which are incorporated herein by reference in their entirety.

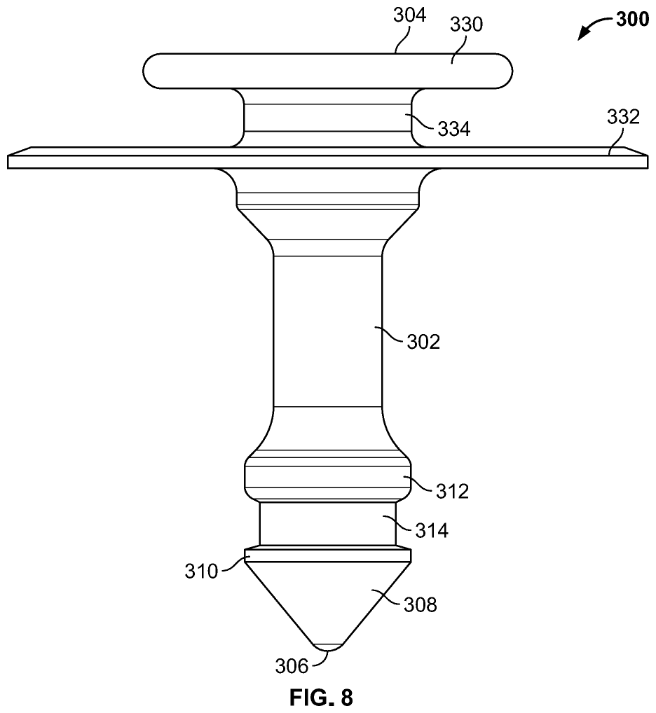

Referring to FIG. 8, a side elevational view of a pin 300 is shown. As illustrated in FIG. 8, the pin 300 comprises a body 302 that includes a top end 304 and a bottom end 306. The body 302 further includes a conical tip 308 at the bottom end 306 of the pin 300. The conical tip 308 extends from the bottom end 306 of the pin 300 to a perimeter wall 310. The perimeter wall 310 is generally cylindrical; however, the perimeter wall 310 may comprise any shape. Furthermore, the pin 300 includes a rib 312 extending outwardly from the body 302. In preferred embodiments, the body 302 of the pin 300 includes a recessed wall 314 that extends between the rib 312 and perimeter wall 310. In this embodiment, the pin 300 also includes a first circular flange 330 and a second circular flange 332 near the top end 304 of the body 302. In particular, the first circular flange 330 is positioned above the second circular flange 332, and the first circular flange 330 and the second circular flange 332 are connected by a neck 334. The first and second circular flanges 330, 332 are generally flat. In preferred embodiments, an additional component (not shown), such as a panel, may be attached to the pin 300 on the neck 334. In particular, the additional component can be fixed between the first circular flange 330 and the second circular flange 332.

Referring to FIG. 9, a perspective view of the grommet 100 and the component 270 is shown. As illustrated in FIG. 9, the component 270 comprises a slot 350 that extends therethrough. The slot 350 comprises a generally rectangular shape, and the slot 350 is defined by internal edges 352 of the component 270. It is contemplated that the component 270 may comprise any thickness or configuration. Further, the component 270 can be any shape and may comprise any type of panel, such as a plastic panel, an aluminum panel, or a metal panel, for example. During assembly, the grommet 100 is aligned with the slot 350 of the component 270. Once aligned, the grommet 100 is urged into the slot 350 in the direction of arrow B. Upon urging of the grommet 100, the legs 231 guide the grommet 100 into a centered position with respect to the slot 350 by aligning with the internal edges 352 of the slot 350. The internal edges 352 of the slot 350 can slide over the extension beam 250 of the legs 231, resulting in the body 102 of the grommet 100 sliding through the slot 350 of the component 270.

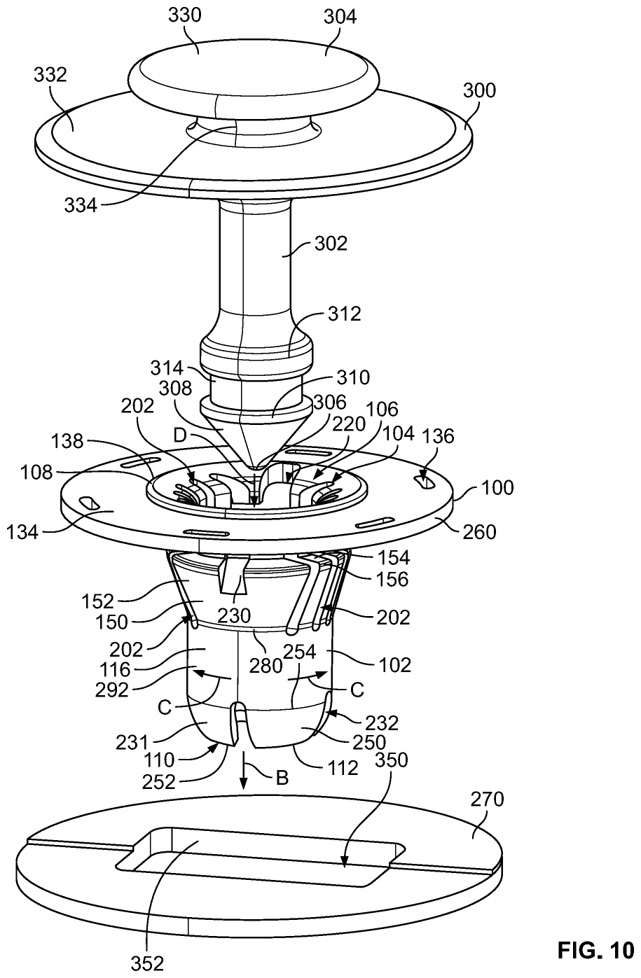

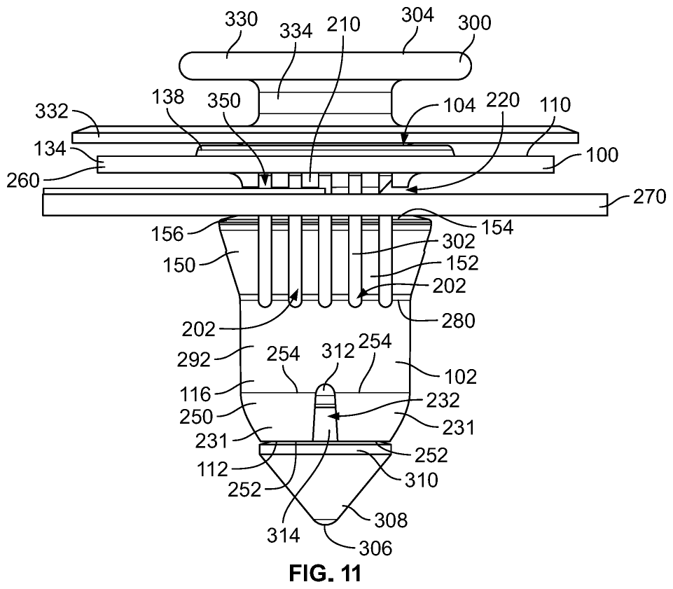

Referring still to FIG. 9, the grommet 100 is allowed to easily slide through the slot 350 of the component 270 until the internal edges 352 of the slot 350 make contact with the angled wall 152 of the box prong 150. As an operator increases the force on the grommet 100 in the direction of arrow B, the box prong 150 will begin to flex inwardly toward the longitudinal axis A (see FIG. 3). The box prong 150 is able to inwardly flex because of the plurality of longitudinal openings 202 that extend through the box prong 150 and the body 102 of the grommet 100. Upon a continued increase of force on the grommet 100, the internal edges 352 of the slot 350 begin to slide over the angled wall 152 of the box prong 150, causing further deflection of the box prong 150 in the direction toward the longitudinal axis A (see FIG. 3). As the internal edges 352 of the slot 350 ride over the rounded corner 156 of the box prong 150, the box prong 150 flexes back to an at-rest configuration. Therefore, the internal edges 352 that define the slot 350 are trapped between the top wall 154 of the box prong 150 and the collar 134 of the grommet 100 (see FIG. 11). As will be discussed in further detail herein, the configuration of the box prong 150 and the plurality of longitudinal openings 202 allow the grommet 100 to be inserted into a non-circular slot, i.e., the slot 350, in any orientation. Therefore, the grommet 100 does not need to be rotated about the longitudinal axis A to a specific orientation before the grommet 100 is inserted into the slot 350 of the component 270. As such, the grommet 100 can be rotated in the direction of arrows C (see FIGS. 9 and 10) to any orientation prior to insertion into the slot 350. As noted herein, the grommet 100 can be used with any type of non-circular slot. However, it is anticipated that in some embodiments, a circular slot may be used.

Referring to FIG. 10, a perspective view of the grommet 100 aligned with the component 270 and the pin 300 is shown. As illustrated in FIG. 10, the pin 300 is aligned above the upper opening 106 of the passageway 104 of the grommet 100. In particular, the conical tip 308 of the pin 300 is positioned directly above the upper opening 106 of the passageway 104. During assembly, the pin 300 and the grommet 100 are aligned as illustrated in FIG. 10. Once aligned, the pin 300 is urged into the upper opening 106 of the passageway 104 in the direction of arrow D. Upon urging of the pin 300, the conical tip 308 guides the pin 300 into a centered position with respect to the upper opening 106 of the passageway 104 by aligning with the inner surface 114 of the wall 116. After the pin 300 is aligned, the pin 300 may slide through the passageway 104 of the grommet 100.

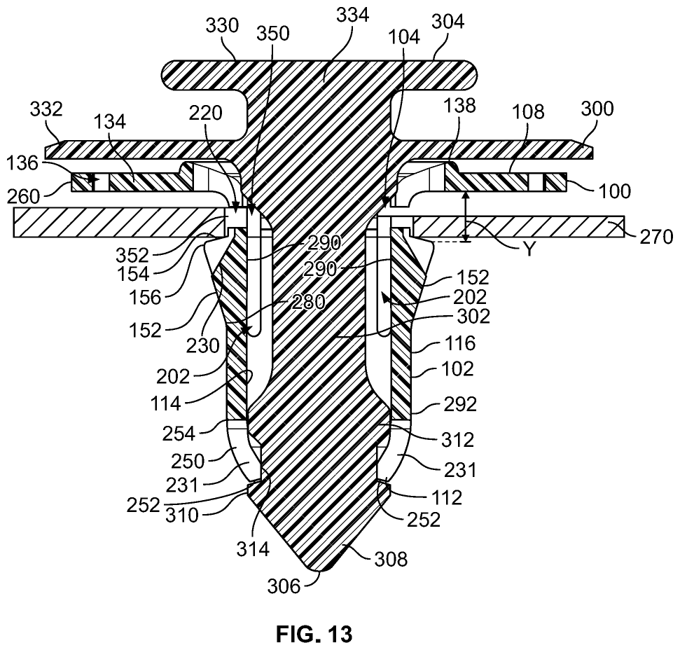

Referring still to FIG. 10, the pin 300 is allowed to easily slide through the passageway 104 of the grommet 100 until the conical tip 308 of the pin 300 makes contact with the legs 231 of the grommet 100. As the operator increases the force on the pin 300 in the direction of the arrow D, the legs 231 of the grommet 100 will begin to flex outwardly due to the shape of the conical tip 308 of the pin 300. In particular, the inwardly-canted tip 252 of the legs 231 will ride along the surface of the conical tip 308 of the pin 300. As discussed above, the legs 231 are capable of pivoting outwardly at the flexure joints 254. As the legs 231 of the grommet 100 ride over the perimeter wall 310 of the pin 300, the legs 231 of the grommet 100 flex back to an at-rest configuration on the recessed wall 314. Therefore, the legs 231 of the grommet 100 are trapped between the conical tip 308/perimeter wall 310 and the rib 312 of the pin 300 (see FIG. 13). Specifically, the inwardly-canted tip 252 of the legs 231 are secured to the body 302 of the pin 300 adjacent to the recessed wall 314 (see FIG. 13). As noted herein, the pin 300 is capable of being detached from the grommet 100.

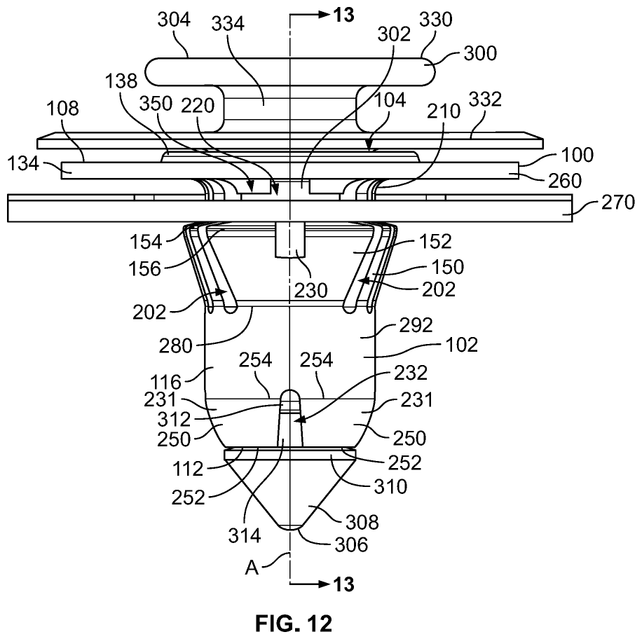

Referring to FIGS. 11-13, various view of the grommet 100 attached to the pin 300 and the component 270 are shown. As illustrated in FIGS. 11-13, the component 270 is positioned between the collar 134 and the top wall 154 of the box prong 150. As noted herein, the pin 300 can be inserted into the grommet 100 prior to the grommet 100 being attached to the component 270. In further embodiments, the pin 300 and the grommet 100 may be shipped to the operator already assembled and attached to each other. In other embodiments, the pin 300 may be inserted into the grommet 100 after the grommet 100 has been attached to the component 270. As discussed above, in some embodiments, the pin 300 is removably attached to the grommet 100 such that the pin 300 and the grommet 100 may be shipped together to the operator attached, but disassembled thereafter prior to being inserted into a vehicle, for example.

Referring still to FIGS. 11-13, the second circular flange 332 is positioned above the collar 134 of the grommet 100. In alterative embodiments, the second circular flange 332 may be flush with the collar 134 of the grommet 100. As discussed above, the component 270 may comprise any type of thickness. Therefore, depending on the thickness of the component 270 the distance Y between the top wall 154 of the box prong 150 and the collar 134 may vary to accommodate the thickness of the component (see FIG. 13). In preferred embodiments, the distance Y can be 0.1 mm to 4.0 mm. In alternative embodiments, the distance Y can be any length. In further embodiments, multiple components 270 may be positioned between the collar 134 and the box prong 150 of the grommet 100. As further discussed above, an additional component (not shown) may be secured to the neck 334 of the pin 300.

Referring back to FIG. 9, the grommet 100 is aligned with the slot 350 of the component 270. However, as discussed above, the grommet 100 does not need to attach to the component 270 in a specific orientation. Instead, the grommet 100 may be attached within the slot 350 of the component 270 in any orientation so long as the legs 231 of the body 102 are led into the slot 350 of the component 270. In particular, the grommet 100 may be rotated about the longitudinal axis A (see arrows C) to any rotational position prior to being inserted into the slot 350 of the component 270. The longitudinal openings 202 in the body 102 and the box prong 150 of the grommet 100 allow for the box prong 150 to inwardly flex regardless of the orientation that the grommet 100 is being placed into the slot 350 of the component 270. Therefore, the operator does not need to orientate the grommet 100 with respect to the rectangular shape of the slot 350. Instead, the operator, in a one-step process, can attach the grommet 100 with or without the pin 300 to the component 270. Thus, the operator does not need to use additional time to make sure that the grommet 100 is properly aligned with the shape of the slot 350 prior to assembly. Rather, the operator can just simply urge the grommet 100 into the slot 350 of the component 270 and the box prong 150 will flex to allow the internal edges 352 of the component 270 to be positioned between the collar 134 and the box prong 150 of the grommet 100.

From the foregoing, it will be appreciated that the grommet 100 eliminates the need to orientate the grommet 100 with the slot 350 during installation. Typical fasteners or grommets for use with non-circular slots require a specific rotational positon prior to being inserted into a panel. In contrast, the grommet 100 may be inserted into a non-circular slot in any rotational position about the longitudinal axis A. Thus, the grommet 100 greatly reduces time and complexity during installation. Furthermore, the longitudinal openings 202 and the windows 220 in the grommet 100 allow the grommet 100 to be more flexible and to have a lower installation force.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

As noted previously, it will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

I claim:

1. A grommet, comprising:
a body defining a longitudinal axis and having a passageway therein;
a collar extending from the body and away from the longitudinal axis; and
a box prong extending circumferentially around the body,
wherein a plurality of longitudinal openings extend through the body and the box prong at diametrically opposed sides, and wherein the grommet is configured to attach within a slot of a component in any orientation.
